(19) United States
(12) Patent Application Publication
(10) Pub. No.: US 2010/0149118 A1
(43) Pub. Date: Jun. 17, 2010

(54) Media controller

(75) Inventor: Jin Yi Huang, Tainan Hsien (TW)

Correspondence Address: BACON & THOMAS, PLLC, 625 SLATERS LANE, FOURTH FLOOR, ALEXANDRIA, VA, 22314-1176, US

(73) Assignee: Ya Horng Electronics Co., Ltd., Tainan Hsien (TW)

(21) Appl. No.: 12/585,324

(22) Filed: Sep. 11, 2009

(30) Foreign Application Priority Data
Dec. 17, 2008 (TW) 097222649

(51) Int. Cl. G06F 13/14; G06F 3/041

(52) U.S. Cl. 345/173; 345/520

(57) ABSTRACT

This invention is to provide a media controller, comprising a touch panel, which is set up to combine with the screen, and each location on the touch panel is equipped with the “touch” feature, where the touch feature is the location at the screen designed to associate with control commands of a multimedia software such that a virtual command of the multimedia software at the screen can be directly controlled by a finger touching at the touch panel; a micro controller unit (MCU), connected with the touch panel and a physical control device, and the MCU receives a command from the touch panel or the physical control device for carrying out operations and for an output, where the control command of the output is transmitted to the PC through a transmitting wire; and the physical control device includes a number of control elements, which empowers the operator to directly control the software virtual control elements on the screen.

### BACKGROUND OF THE INVENTION

1. Field of the Invention

This invention relates generally to media controllers and more specifically to one capable of direct control of the software virtual control elements on the screen, which enables greater accuracy in manipulating the commands, where the operation also includes simultaneous manipulation of a real physical control device, which would achieve greater authentic feeling in the control of sound effects.

2. Description of the Prior Art

Prior art media controllers for making music sound effects are controlled by using the computer mouse to manipulate the multimedia software commands on the screen. Operators (for instance: controlling sound effects as DJ) always stand to operate a mouse at work, which is painful to manipulate the multimedia control commands on the screen, and the situation for the use of the mouse to manipulate the multimedia control commands to carry out rotational movements is especially hard to control. If the control of sound effects is only by manipulating the computer mouse and there is no real physical control knob for the control, it would give the operator an inauthentic feeling when comparing with the handling of traditional DJ turntables. The other example is a standalone physical controller, having a number of fixed physical control knobs, which surely eases the manipulation by the standing operator (for instance: controlling sound effects as DJ). However, as the associated software keeps upgrading and features continue boosting, the physical controller would have the drawbacks for failing to operate in coordination with the upgraded multimedia software.

### SUMMARY OF THE INVENTION

In the light of the aforesaid drawbacks, the present inventor conceived the idea of the improvement after a longtime endeavor, and eventually the endeavor gave birth to this invention.

The objective of this invention is to provide a media controller, capable of direct control of the software virtual control elements on the screen, which substantially lifts the accuracy of the manipulation of the commands. With the simultaneous control of a physical control device, the control of sound effects would achieve greater authentic feeling.

To achieve the aforementioned objective, the media controller of this invention comprises a touch panel, which is set up to combine with the screen, with an appearance in transparency, and each location on the touch panel is equipped with the “touch” feature, where the touch feature is the location at the screen designed to associate with corresponding control command of a multimedia software such that a virtual command of the multimedia software at the screen can be directly controlled by a finger touching at the touch panel; a micro controller unit (MCU), connected with the touch panel and a physical control device, the MCU receives a command from the touch panel and the physical control device for carrying out operations and for an output, where the control command of the output is transmitted to the PC through a transmitting wire; And the physical control device includes physical control elements for offering the operator a real hand control. Accordingly, this design empowers the operator to have direct control of the software virtual control elements on the screen, substantially lifting the accuracy of the manipulation of the commands. With the simultaneous control of the physical control device, the control of sound effects would achieve greater authentic feeling.

### BRIEF DESCRIPTION OF THE DRAWINGS

FIG. 1 is a block diagram of the first embodiment of this invention;

FIG. 2 is a block diagram of the second embodiment of this invention;

FIG. 3 is a block diagram of the use of two different output screens to replace the same screen of the PC of the second embodiment of this invention; and

FIG. 4 is a block diagram of the use of the video interface adaptor of the second embodiment of this invention.

### DETAILED DESCRIPTION OF THE INVENTION

To achieve the aforesaid objects of this invention, the technique adopted and the function achieved are detailed described with reference to the following preferred embodiments and the accompanying drawings

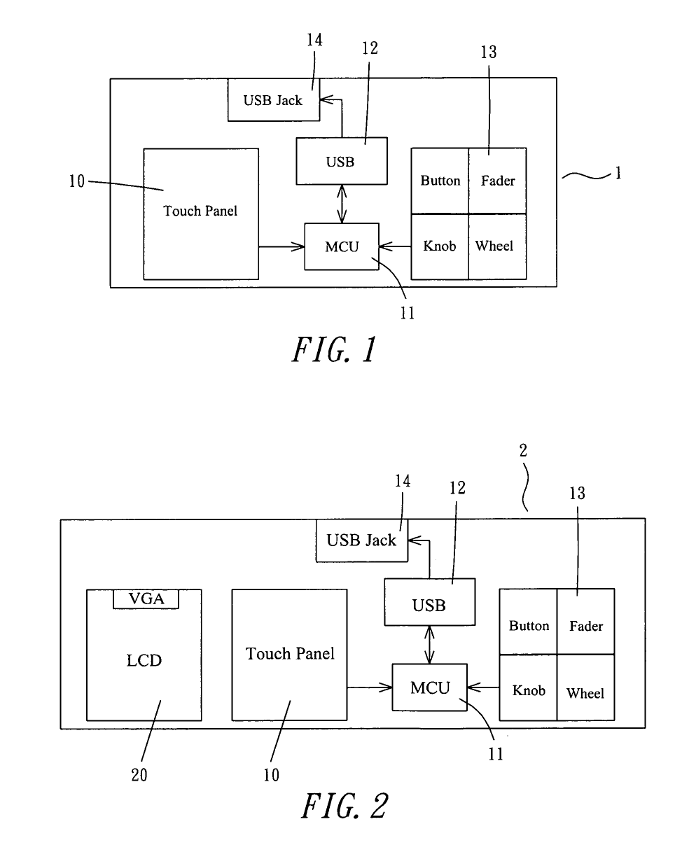

Referring to FIG. 1, FIG. 1 is a block diagram of the first embodiment of this invention, and the media controller 1 of this invention comprises:
a touch panel 10, where the touch panel 10 is set up to combine with the screen, with an appearance in transparency. And each location on the touch panel 10 is equipped with the “touch” feature, where the touch feature is the location at the screen designed to associate with control commands of a media software such that virtual commands of the multimedia software at the screen can be directly controlled by a finger touching at the touch panel 10;
1. a micro controller unit (MCU) 11, connected with the touch panel 10 and a physical control device 13, where the physical control device 13 is made up of control elements: such as button, knob, fader, wheel and the like, while the MCU receives a command from the touch panel 10 and the physical control device 13 for carrying out operations and for an output, where the control command of the output is transmitted to a universal serial bus (USB) 12, where the output end of the USB 12 is connected to a USB jack 14, and the USB jack 14 is connected to a USB jack of the PC by a USB transmitting wire. Moreover, the control elements of the physical control device 13 offer the operator controlling features such as adjusting volume, audio frequency during the play of a multimedia product.

When manipulating multimedia software, a user touches the touch panel 10 corresponding to the location of a control command of the multimedia software shown on the LCD by the left hand, followed by the manipulation of the physical control device 13 by the right hand. After the operations by the MCU 11, the outcome of the operations is transmitted to the PC through the USB 12 and the USB jack 14. It makes sure that the display of a multimedia (music videos) under the control of a PC is actually an outcome of the manipulation by the operator.

Referring to FIG. 2, FIG. 2 is a block diagram of the second embodiment of this invention, where the media controller 2 is one that adds a LCD 20 to the aforesaid first embodiment of the media controller 1, where the LCD 20 is connected with the screen of the PC. Once the multimedia software of the PC is executed, control commands will show on the LCD 20. As the touch panel 10 is linked to the LCD 20, a touch by hand to the touch panel 10 can directly control the virtual control commands of the multimedia software on the LCD 20.

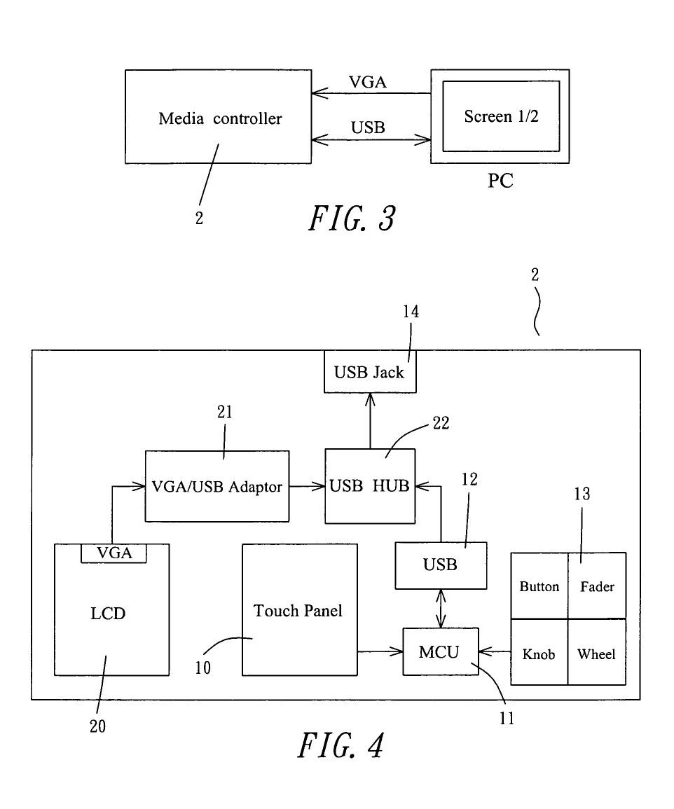

Referring to the block diagram shown in FIG. 3, where the screen of the PC can be two different output screens so that the picture displayed on the LCD 20 of the media controller 20 is the picture of a virtual control command after the execution of the multimedia software.

Lastly, referring to FIG. 4, the embodiment is designed to simplify the connection between the media controller 2 and the PC shown in FIG. 2, where the LCD 20 of the media controller 2 may be connected with a video interface adaptor 21 (for instance: VGA/USB adaptor), for the converting the video interface into the USB interface, and both the output end of the video interface adaptor 21 and the USB 12 are connected to a USB HUB 22, where the USB HUB 22 joins a USB jack 14 at its output end. Therefore, the media controller 2 owns a LCD 20 and connects to the PC for the output of the control commands. However, a single USB transmitting wire is available for accomplishing the connection to the PC for this design, which substantially eases the connection between the media controller 2 and the pc.

Accordingly, through the carrying of the touch panel of the media controller on the LCD, and through the planning of multiple feature keys on the touch panel corresponding to the control commands of the multimedia software displayed on the LCD, the operator touches a feature key of the touch panel which corresponds to the control command of the picture on the LCD by the left hand, followed by the manipulation of the physical control device by the right hand. After the operations by the MCU, the outcome of the operations is transmitted to the PC, to enable the PC to have a corresponding output. This empowers the operator to directly control the software virtual control elements on the screen, which substantially lifts the accuracy of the manipulation of the commands. With the control of the physical control device simultaneously, the control of sound affects would have greater authentic feeling.

In conclusion, the present invention is construed to be creative and useful aside from novel; which is compliant to the utility patent requirements; an application is now filing for utility patent according to the law, which deserves your favorable examination and approval.

What is claimed is:

1. A media controller, comprising:
a touch panel, set up to combine with the screen, with an appearance in transparency, and each location thereon being equipped with touch feature, where the touch feature is the location at the screen designed to associate with control commands of a media software such that a virtual command of the multimedia software at the screen being directly controlled by a finger touching at said touch panel;
a micro controller unit (MCU), connected with said touch panel and a physical control device, said MCU receiving a command from said touch interface and the physical control device for carrying out operations and for an output, and the control command of the output being transmitted by a connecting wire to a PC;
a physical control device, having physical control elements for offering operators a real physical control.

2. A media controller as in claim 1 wherein the control command outputted by said MCU is transmitted first to a USB, where the output end of the USB is connected to a USB jack, and the USB jack being connected to a USB jack of the PC by a USB transmitting wire.

3. A media controller as in claim 1 wherein the physical control device includes control elements: button, knob, fader and wheel.

4. A media controller as in claim 1 wherein the media controller is capable of adding of one more LCD, where the LCD is connected with the screen of the PC.

5. A media controller as in claim 4 wherein the screen of the PC may be two different output screens, such that the picture displayed on the LCD of the media controller being the picture of a virtual control command after the execution of the multimedia software.

6. A media controller as in claim 4 wherein the LCD of the media controller may be connected with a video interface adaptor, for the conversion of the video interface into the USB interface, and both the output end of the video interface adaptor and the USB being connected to a USB HUB, where the USB HUB joins a USB jack at its output end, and the USB jack joining the pc through a USB transmitting wire.

7. A media controller as in claim 6 wherein the video interface adaptor may be a VGA/USB adaptor.
